(19) United States
(12) Patent Application Publication
(10) Pub. No.: US 2009/0302518 A1
(43) Pub. Date: Dec. 10, 2009

(54) Portable Clamp

(76) Inventor: Shane Harriden, New South Wales (AU)

Correspondence Address: Shane Harriden, PO Box 1300, Coolum Beach, QLD, 4573, AU

(21) Appl. No.: 12/092,577

(22) PCT Filed: Feb. 1, 2007
(86) PCT No.: PCT/AU07/00588

§ 371 Date: Oct. 2, 2008

(30) Foreign Application Priority Data
Feb. 14, 2006 (AU) 2006900714

(51) Int. Cl. B25B 5/12; B25B 5/04

(52) U.S. Cl. 269/228; 269/237; 269/271

(57) ABSTRACT

There is provided a portable clamp suitable for clamping workpieces together, the portable clamp including: a mounting member; a pivoting clamping member pivotally connected to the mounting member at a pivot; a reaction member mounted to the mounting member at a region distal the pivot; and a locking means to lock the pivoting clamping member to inhibit rotation of the pivoting clamping member relative to the mounting member so that, when in use, one or more workpieces are clamped between the pivoting clamping member and the reaction member. The locking means is an overcentre mechanism.

### FIELD OF THE INVENTION

The present invention relates generally to clamps suitable for use in clamping workpieces together, or for clamping a workpiece against a support or like clamping applications.

### BACKGROUND TO THE INVENTION

It is known to provide clamps such as vices, sash cramps and the like which are cumbersome and although can bring a great deal of force to bear on workpieces over large distances, they are heavy and require two hands to actuate. Single-handed actuating clamps are available but can only bring to bear lower clamping forces and/or have limited accommodation for workpieces, so are only useful for smaller jobs.

The present invention seeks to ameliorate one or more of the above-mentioned disadvantages.

### SUMMARY OF THE INVENTION

According to one aspect of the present invention there is provided a portable clamp suitable for clamping workpieces together, the portable clamp including: a mounting member; a pivoting clamping member pivotally connected to the mounting member at a pivot; a reaction member mounted to the mounting member at a region distal the pivot; and a locking means to lock the pivoting clamping member to inhibit rotation of the pivoting clamping member relative to the mounting member so that, when in use, one or more workpieces are clamped between the pivoting clamping member and the reaction member.

Preferably the locking means is connected to an actuating means so as to integrate the actions of locking and actuating the clamp into one clamping movement. In one form the locking means is an overcentre mechanism. In one preferred embodiment the overcentre mechanism is a four-bar mechanism.

Preferably, the mounting member is an elongate member, in one form being a spine. The spine may have additional strengthening means such as a flange so that the spine forms a T-beam or C-beam or the like.

In one form, a first or ground bar of the four-bar mechanism is an end portion of the mounting member. In this embodiment two opposed vertices of the ground member mount pivots for second and fourth bars of the four-bar mechanism. Preferably a third member is pivotally mounted on the pivoting second and fourth bars.

Preferably, handles extend from the second and third bars, and a clamping head and neck extend from the fourth bar, so as to obtain increased mechanical advantage.

Preferably a stop is provided so that the second and fourth bars abut one another when the locking mechanism is actuated. In one form the stop is in the form of flanges or cheeks of the second and fourth bars of the four-bar mechanism.

Preferably the action of squeezing the handles together engages the lock, pivots the pivoting handle and forces the clamping head toward a head of the reaction member.

In one embodiment the reaction member is mounted on a carriage which is in turn removably mounted to the mounting member such as by a spring-loaded pin. The carriage, in this embodiment, is adapted to slide along the mounting member and adapted to be remounted in a selected aperture further distal the pivoting clamping member to accommodate larger workpieces.

Preferably the head of the reaction member is adjustable so that fine adjustments may be made to accommodate varying sizes of workpiece. In one form the adjustable head is a threaded bar having a clamping bulb and a knurled handle so that in use the handle may be turned to enable the fine adjustments to a clamping aperture.

### DESCRIPTION OF THE PREFERRED EMBODIMENTS

In order to enable a clearer understanding, the invention will hereinafter be described with reference to drawings and description of preferred embodiments. In the drawings:

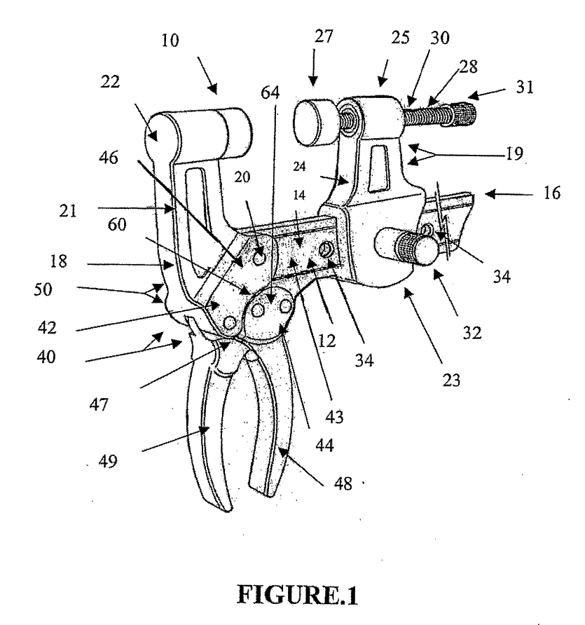

FIG. 1 is an isometric view of a portable clamp according to a preferred embodiment of the present invention;

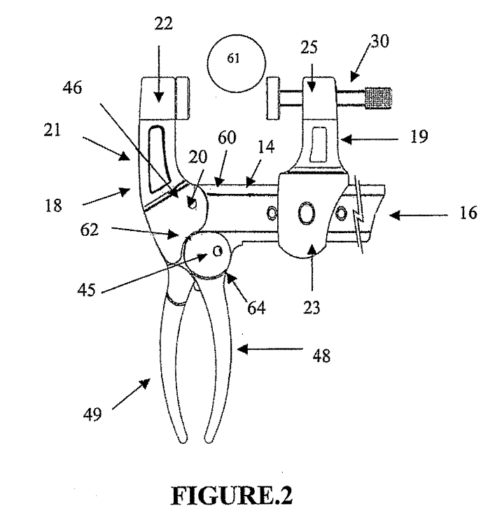

FIG. 2 is a right side elevation view of the portable clamp shown in FIG. 1;

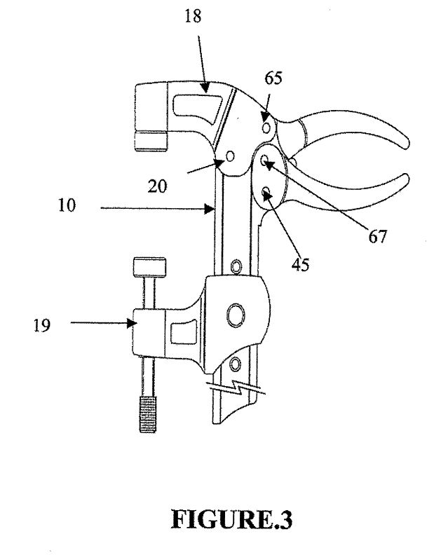

FIG. 3 is a left side elevation view of the portable clamp shown in FIG. 1;

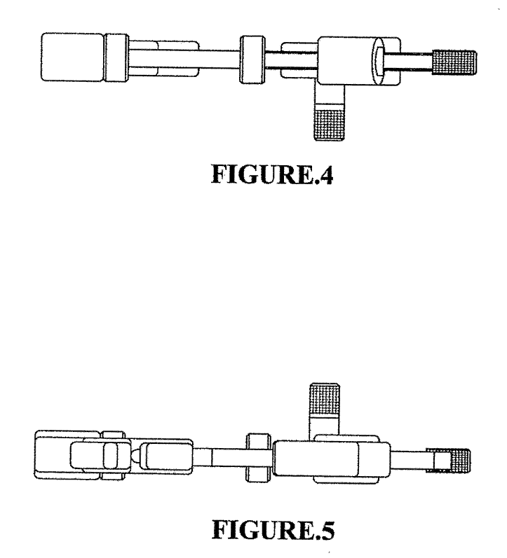

FIG. 4 is a plan view of the portable clamp shown in FIG. 1;

FIG. 5 is a plan view from underneath of the portable clamp shown in FIG. 1;

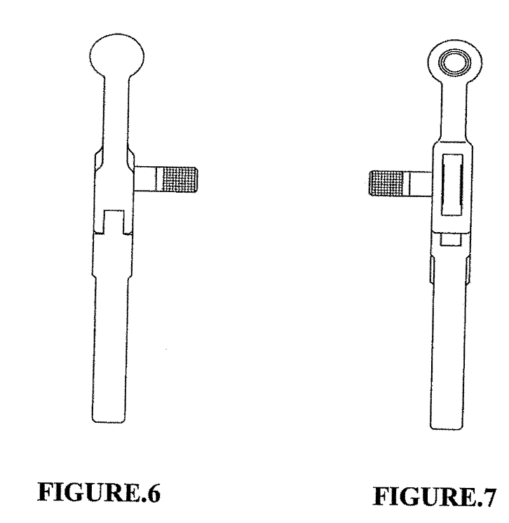

FIG. 6 is a rear end elevation view of the portable clamp shown in FIG. 1;

FIG. 7 is a front end elevation view of the portable clamp shown in FIG. 1;

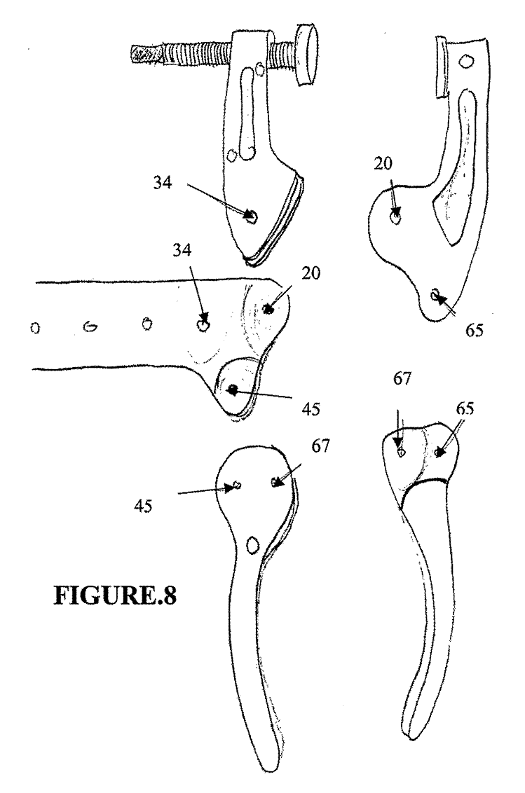

FIG. 8 is an exploded view of a clamp very similar to that shown in FIG. 1;

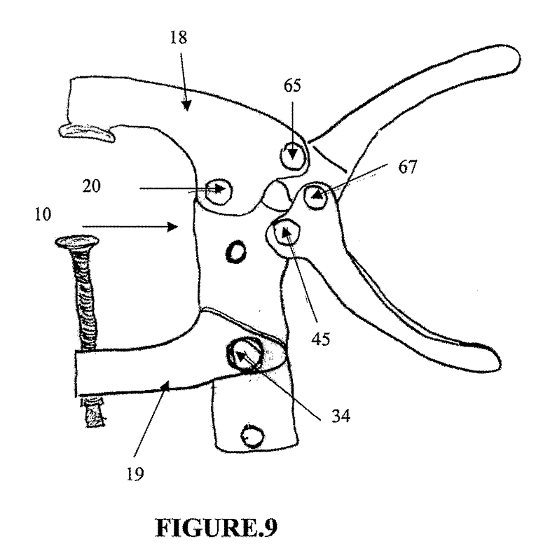

FIG. 9 is a left side elevation view of a clamp similar to that shown in FIG. 1, the clamp being in a release position;

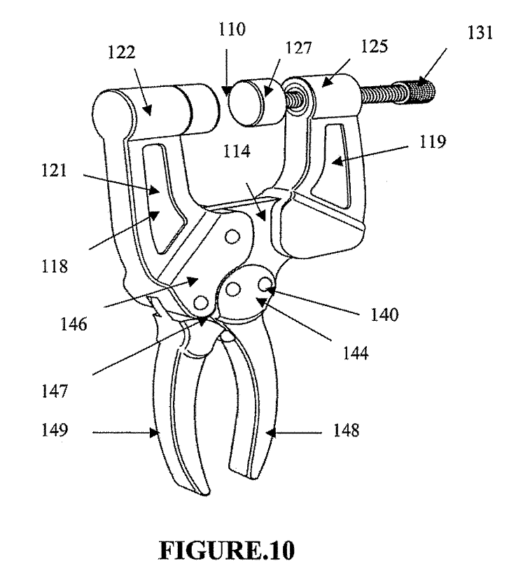

FIG. 10 is an isometric view of a portable clamp according to a second preferred embodiment of the present invention;

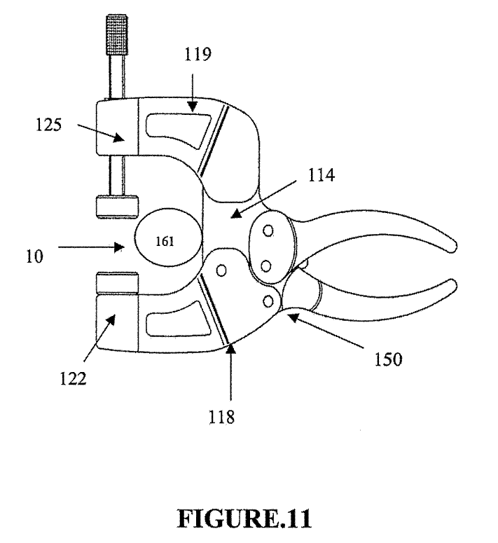

FIG. 11 is a right side elevation view of the portable clamp shown in FIG. 10;

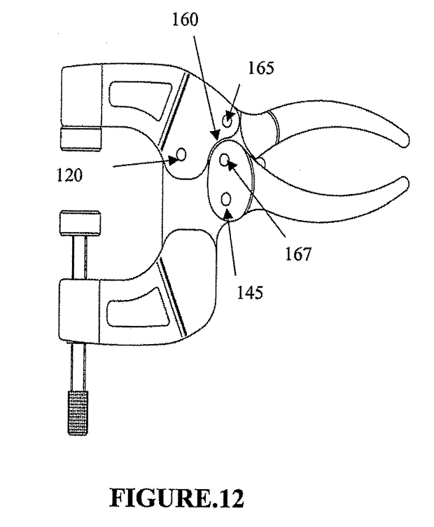

FIG. 12 is a left side elevation view of the portable clamp shown in FIG. 10;

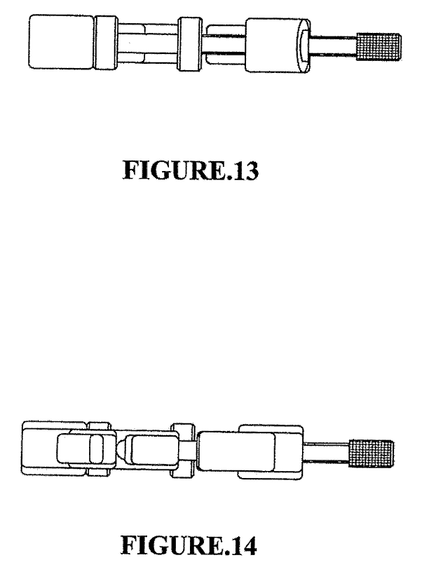

FIG. 13 is a plan view of the portable clamp shown in FIG. 10;

FIG. 14 is a plan view from underneath of the portable clamp shown in FIG. 10;

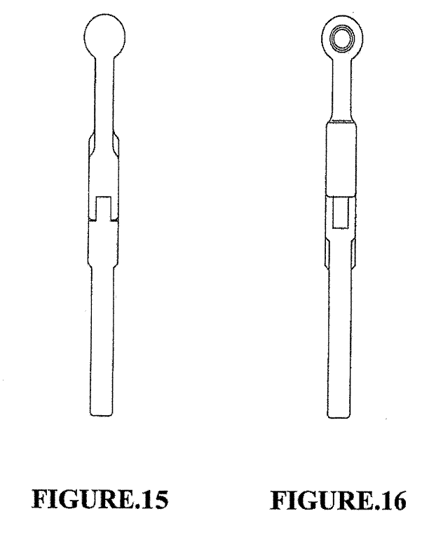

FIG. 15 is a rear end elevation view of the portable clamp shown in FIG. 10;

FIG. 16 is a front end elevation view of the portable clamp shown in FIG. 10.

Referring to FIG. 1 there is shown a portable clamp generally indicated at 10 including a mounting member 12 in the form of a spine 14, the spine 14 in the form of an I-beam 16 for additional strength.

A pivoting clamping member 18 is mounted to the mounting member 12 at a pivot 20. The pivoting clamping member 18 includes a neck 21 and clamping head 22, the latter of which is forced against a workpiece (not shown) when the clamp 10 is actuated.

Mounted on the spine 14 at a region distal the pivoting clamping member 18 is a reaction member 19 which includes a carriage 23 upon which is mounted a reaction neck 24 and a head assembly 25. The head assembly 25 includes a clamping bulb 27 and an adjustment means 28 in the form of a threaded bar 30 so as to make fine adjustments. A knurled knob 31 is rotated in order to advance or retract the clamping bulb 27 before clamping.

The carriage 23 is mounted to the mounting member 12 by a pin 32 which passes through apertures 34. Coarse adjustments may be made by removing the pin 32 from a selected aperture 34 and sliding the carriage 23 to another selected aperture 34. This allows the accommodation of a wide range of sizes and shapes of workpieces.

A locking means 40 is provided in the form of a four-bar mechanism 42. The four-bar mechanism includes a first or ground bar 43, a second bar 44 pivotally connected thereto at a lower rear vertex pivot point 45, a fourth bar 46 connected to another vertex at pivot point 20, and a third bar 47 pivotally connected to both the second bar 44 and fourth bar 46. Handles 48 and 49 extend from the second bar 44 and third bar 47 so as to improve mechanical advantage. The neck 21 reduces mechanical advantage, but a balance must be struck between mechanical advantage and convenient size of workpiece accommodated.

The locking means 40 is in the form of an overcentre mechanism 50 which is relatively easy to overbalance and force into a locking position (shown in FIGS. 1-7). Also, releasing the locking means 40 is a simple matter of pulling the handles 48 and 49 apart, through a balance point and then open (as shown in FIG. 9).

An exploded view shown in FIG. 8 demonstrates the assembly and connection points of the various bars. The connecting pivot points are labelled with matching numerals.

A stop 60 is provided which stops the pivoting clamping head 22 from entering a clamping void 62 too far, and reducing the clamp's effectiveness. The stop 60 is in the form of flanges or cheeks 64 of the second bar 44 and third bar 47 which abut to define a closed position.

A second embodiment shown in FIGS. 10-16 does not include a carriage-mounted reaction member 119. In other aspects, the invention is substantially the same as the first embodiment, where the reaction member 119 is mounted distal the pivoting clamping member 118.

In operation, a workpiece is placed in the clamping void 62, and a coarse adjustment made by moving the carriage 23 to an appropriate aperture 34. A fine adjustment is made to the clamping bulb 27. The handles 48 and 49 are squeezed together until the pivoting clamping member 18 and its head 22 contact the workpiece, and if the adjustment has been made correctly, slight pressure will be felt as the balance point is reached and overcome and then the cheeks 64 abut shortly after that point, and the clamp is locked around the workpiece or workpieces. Work may then commence on the workpiece.

Coarse and fine adjustment may require two hands, but the final actuation requires only one hand, so that the workpieces may be steadied with the other hand.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1. A portable clamp including: a first jaw member and a second jaw member mounted in a spaced apart manner on a spacer member, at least the first jaw member pivotally connected to the spacer member so as to pivot between an open position and a clamped position in which one or more workpieces are clamped between the first and second jaw members; an overcentre locking means associated with at least the first jaw assembly movable between a free position associated with the open position and a locked position associated with the clamped position for locking the first jaw member against rotation relative to the spacer member when the first jaw member is in the clamped position; wherein a first and a second pivoting actuating arms are provided, the first actuating arm being associated with the first jaw member and the second actuating arm being associated with the spacer member, the actuating arms being linked so that in use movement of one actuating arm causes the movement of the other actuating arm to move the overcentre locking means between the free position and the locked position.

2. A portable clamp in accordance with claim 1 wherein the overcentre locking means includes a four-bar mechanism in which a pivot moves across a balance point to lock the mechanism in the locked position, wherein the bars connected to the pivot are locking bars of generally equal length.

3. A portable clamp in accordance with claim 2 wherein the four-bar mechanism includes two stabiliser bars of approximately double the length of the locking bars.

4. A portable clamp in accordance with any one of the previous claims wherein the second jaw assembly is mounted on a carriage so as to move the second jaw member towards and away from the first jaw member, the carriage engaging with the spacer member via a follower aperture and locking to the mounting member in a selected position relative to the first jaw member via a carriage locking means.

5. A portable clamp in accordance with claim 4 wherein the carriage locking means comprises a locking pin extending though the carriage and into the mounting member.

6. A portable clamp in accordance with any one of the previous claims wherein a fine adjustment means is provided wherein one of the jaw members includes an extensible region which can extend or retract, toward or away respectively from the other jaw member.

7. A portable clamp in accordance with claim 6 wherein the extensible region is a head region of the jaw member.

8. A portable clamp in accordance with claim 7 wherein the extensible head includes a threaded bar.

9. A portable clamp in accordance with claim 8 wherein the threaded bar extends from the second jaw head.

10. A portable clamp substantially as hereinbefore described with reference to the attached drawings.
